(19) United States
(12) Patent Application Publication
(10) Pub. No.: US 2005/0015504 A1
(43) Pub. Date: Jan. 20, 2005

(54) Resource management method and apparatus

(76) Inventors: Raphael JH Dorne, Ipswich (GB); David Lesaint, Paris (FR); Gilbert K Owusu, Barking (GB); Christos Voudouris, Ipswich (GB)

Correspondence Address: Nixon & Vanderhye, 8th Floor, 1100 North Glebe Road, Arlington, VA, 22201-4714, US

(21) Appl. No.: 10/487,253

(22) PCT Filed: Sep. 11, 2002
(86) PCT No.: PCT/GB02/04153

(30) Foreign Application Priority Data
Sep. 13, 2001 (EP) 01307806.8
Mar. 15, 2002 (GB) 0206249.5

(51) Int. Cl. G06F 15/16

(52) U.S. Cl. 709/229; 709/223

(57) ABSTRACT

The invention relates to resource management, and describes a method and apparatus to be used in planning of resource deployment. In an embodiment of the invention, the number and characteristics of forecasted and/or unprocessed jobs falling within a time period such as a week, or a month, are compared to resource availability and status for that time period, in terms of attributes such as location, skills and time. A cost—in terms of jobs that cannot be carried out, given current resource availability and status—is evaluated. Preferably the attributes are stored as resource records, so that there is one resource record per resource, and the attributes of at least some of the resource records are modified using a heuristic search means or similar. The resource records are modified until a minimum cost is identified, and these resource records can then be used to formulate successive capacity plans, which can be input to a scheduling system.

The present invention relates to apparatus for and a method of resource management.

Resource management comprises resource planning and resource scheduling, and is concerned with deployment of resources to jobs or tasks. One of the goals of resource management is to reduce operational costs and improve quality of service associated with the resource deployment. Resource planning is concerned with identifying potential resource utilisation in terms of number of resources corresponding to type of jobs on the basis of forecasted and where appropriate, actual volumes of work (resource planning is said to be coarse-grained). Resource scheduling is concerned with assigning resources to actual jobs and identifying explicit execution times for those jobs (resource scheduling is said to be fine-grained). Resource planning is an essential pre-cursor to successful resource scheduling: resource planning can be used to strategically arrange the right amount and type of resources in preparation for scheduling of actual jobs.

A problem with existing resource management systems is that resource planning, if done at all, is only done at a coarse-grain level and very rarely accounts for the dynamic nature of resource management (e.g. unanticipated events such as resources being unavailable at short notice, change in weather conditions, which makes travelling difficult in the case of mobile resources, and so forth). This often leads to a gap between planning and scheduling.

As stated above, resource scheduling operates at a fine-grain level, meaning that the scheduling part of resource management systems has to identify actual resources that can carry out actual jobs that need scheduling. This can often lead to costly assignment of resources to jobs, as the resource scheduling part makes scheduling decisions on the basis of fixed information about the resources, which at this stage, cannot be changed. Consider the following illustrative scenario: a job J1, which needs skill sk1, and is located at L1, needs to be scheduled today D1. Assume that only two resources have this skill: R1 and R2. Assume that R2, who is located near to L1, is off-line today D1; assume also that R1 is located at L3, which is far from L1. As R1 is off-line, and the job J1 has to be carried out today D1, the resource scheduling part has no choice but to assign resource R2 to job J1. The requisite movement of resource R2 from location L3 to L1 incurs significant travel costs.

If the resource planning part were operable to modify attributes of the resources, as well as numbers of resources, it may have seen that although R1 was off-line, it had flagged up its availability for working overtime on days when it is off-line. Thus it could have activated resource R1 on day D1, meaning that R1 could carry out job J1, involving little or no travel costs. (The assumption here being that it is less costly to bring R1 on overtime than let R2 travel to L1).

Clickplan™ is one of several companies specialising in developing scheduling and planning software. One of their press releases, entitled “ClickSoftware Announces First Intelligent Capacity Planning Tool For The Service Industry”, identifies the need to assess, in advance, how well or badly, resources are likely to meet predicted demand. This press release was published October 2000, and, at August 2002, is available from pttp://www.clicksoftware.com/press.asp?csid=49&archive=1. Usually a URL takes the form of a first part indicating the network delivery mechanism (e.g. http:// or file:// for the hypertext transfer protocol or file transfer protocol respectively) followed by the network address of the server (e.g. www.server 1.com) suffixed with the name of the file that is being requested. Note that, in the examples given, such names are, for typographical reasons, shown with “http” replaced by “pttp”.

In particular, this press release states: “ClickPlan analyzes the forecasted work by timeframe, job type, skill requirements, and geographic territory. It analyzes available and allocated resources while taking into consideration hours worked, overtime policies, work rules, service level commitments, holidays and vacations, and other factors that influence the capacity of the service force. As resources are allocated, ClickPlan highlights potential shortages, surpluses, and imbalances in the workforce.” Thus ClickPlan™ enables a workforce manager to identify potential shortfalls in resources, so that he can rearrange the resources ahead of time. This press release does not, however, describe the actions that can be taken once such shortages, surpluses etc. have been identified.

According to embodiments of the present invention, there is provided a method of planning resource utilisation in respect of job requirements, the job requirements comprising a plurality of jobs to be carried out over a plurality of days, the method comprising the steps of:
receiving a plurality of resource records, each record being associated with a resource and comprising data identifying attributes thereof;
receiving job data identifying attributes of the plurality of jobs;
evaluating, on the basis of both types of attribute data, a match between resource availability and job requirements;
modifying attributes of at least some of the resource records, and repeating the evaluation step in respect of the modified resource records; and
selecting resource records that best match resource availability to job requirements.

A resource record in this context will usually be a set of one or more values for factors, or attributes, which describe status, capacity and capability of a resource. For instance, in relation to workload an available set of attributes might be availability, location, capability for doing different types of work (“skill”) and productivity. The resource record for a resource component based on those attributes might then hold values for at least some of those attributes.

A resource record can alternatively be referred to as a profile, and resource planning can be considered to include an additional process, herein referred to as resource profiling, where resource records are optimised in accordance with the invention. Accordingly resource records are generated in the light of predicted workload, which includes known tasks and predicted tasks based on, for example, historical data and known patterns in workload. The resource records are adapted with a view to matching configuration of skills, availability and locations of the resources to the skills, timing and locations of the tasks making up the workload. This means that when a scheduling part schedules the tasks, it uses data that implicitly satisfies the job requirements.

The workload data used for resource record assignment can be predictive rather than actual data, based at least in part on known workload patterns. Resource record assignment and scheduling of actual workload may be done at different times: scheduling of workload can be carried out at the beginning of every working period, perhaps daily, while the assignment of resource records might be carried out in respect of a week's worth of jobs.

Assignment of a resource record may be done for instance by first determining available attributes for the resource record, selecting from amongst the available attributes, and assigning values for the selected attributes to the resource record.

In preferred embodiments of the present invention, the system further comprises optimisation means for optimising the assignment of values to attributes on the resource record. This might involve reviewing an allocated workload, amending one or more resource records, making a fresh allocation of workload and reviewing the fresh allocation against the earlier allocation in order to choose the better resource record(s). These steps can be repeated until some predetermined criterion, such as the number of repetitions reaches a preset limit, is satisfied, or the optimisation process times out.

In order to optimise the selection of values of attributes of resource records, there needs to be at least one parameter that can be compared between allocated workloads. This can be chosen according to circumstance, but it might be for instance the amount of unallocated workload remaining, or the unallocated workload of a particular type or types. Different workload types may have different priorities, such as urgency or cost, and this can be taken into account.

The manner in which cost is calculated for unallocated workload can be used to prioritise particular types of work and this offers an excellent way to manipulate the resources to meet ongoing requirements. For instance, if work of a particular kind is process-critical, it becomes important that resources are assigned to deal with that kind of work. Usually, a particular kind of work will require particular capabilities to be available. In the method described above, which is preferably recursive, it is possible to weight the resource record selection towards resource records that will allow more of the process-critical work to be allocated. In a first alternative manner this involves weighting the cost of such work so that it becomes more expensive if left unallocated than if it is allocated. The result will be that the recursive process will encourage resource records to be selected which contain the attributes and/or values which support that kind of work in preference to other attributes and/or values.

In a second alternative approach, which can be used alone or in combination with the first alternative, a cost function can be used to weight the selection of attributes and/or values of one or more resource records. In this approach, assignment costs are used at least in part as a measure of resource record selection. If it has been recognised that one or more attributes and/or values are going to be important, for instance over a particular period to meet a known workload content, then the assigned cost of the attribute(s) and/or value(s) can be reduced relative to its unassigned cost.

In a third alternative, an attribute and/or value can be designated as “essential” in the resource record of one or more resources. This is relatively efficient, though potentially less flexible, since it reduces the number of permutations the system has to cost for assigned resource records and/or allocated workload.

Particularly advantageously, a warning system can be implemented, via the above-mentioned cost function, which raises an alert related to overutilisation of resource. This is done by introducing a “dummy” record of a resource which has a relatively high cost associated with it. An alert is raised if workload is allocated to it as this will usually mean resources must be overstretched. The warning system can also be arranged to monitor underutilisation of resources by checking for low or zero allocation to a resource.

As work patterns show repetitive behaviour, for instance in relation to the working week, embodiments of the invention can utilise work pattern data to proactively organise resource deployment. In anticipation of actual job requirements, resources can be brought online, moved or taken out of service at times that have minimal impact on workload.

An advantage of embodiments of the present invention is that they can be used to meet the requirements of particular events or campaigns: data representative of expected demand for the event or campaign can be used as workload data, and resource records then adapted with a view to matching allocation of capabilities and capacities to the event data. Thus when the event occurs, resources are automatically available to meet the demand.

The content of a resource record is clearly important since it is key to the recursive process and it can have a very significant relationship with the parameter or parameters chosen for comparison of effectiveness of the allocated workloads. If the environment in which the workload is to be carried out is static and the location of the component is known, then the resource record may not include a value for the location attribute at all but may include values for each of the other attributes, such as “1” to indicate full availability, “sk1, sk2” to indicate the resource component has two specific skills and “5, 10” to indicate it can perform 5 tasks an hour which use skill “sk1” and 10 tasks an hour which use “sk2”.

Resource records generated in accordance with the invention can be used to schedule tasks to resources in a workforce management system. Although this is of course a resource involving people, it is a close equivalent to a resource involving machines, because attributes of a resource record are equally applicable to machines and to people. As an example, a resource record for a technician might include attributes for skill, productivity, area, state (ie availability) and preferences. In a machine, these, or similar, attributes apply, representing for instance what the machine is designed and equipped to do (skill), what rate it is capable of working at (productivity), geographical or network location (area), availability, taking into account, for example, downtime or prebooking for non-system tasks (state) and preferred behaviour such as being used for particular tasks or in particular positions (preferences). The preferences might arise for instance out of operational facts such as having limited data storage backup available which makes a database capable but unsuitable for storing critical data types, or certain network locations being preferred for information processing because the bulk of the information is generated close to those network locations.

Resource records can also be generated for call centre equipment, as it can be very important to have sufficient capacity available at specific times and in specific places in order to process valuable calls.

Embodiments of the invention will now be described, by way of example only, with reference to the accompanying figures, in which:

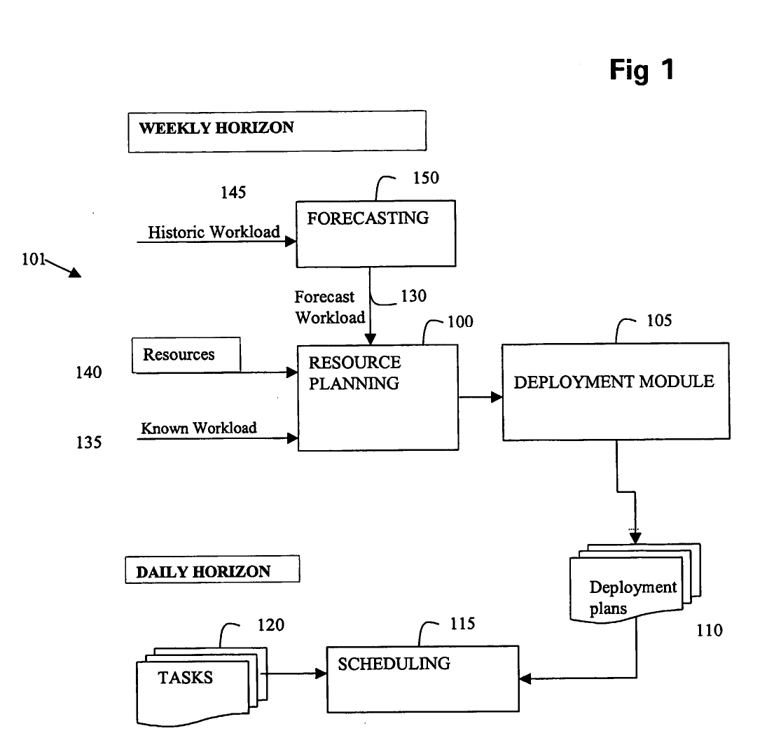

FIG. 1 is a schematic block diagram showing elements of a resource management system in which the embodiments might be used;

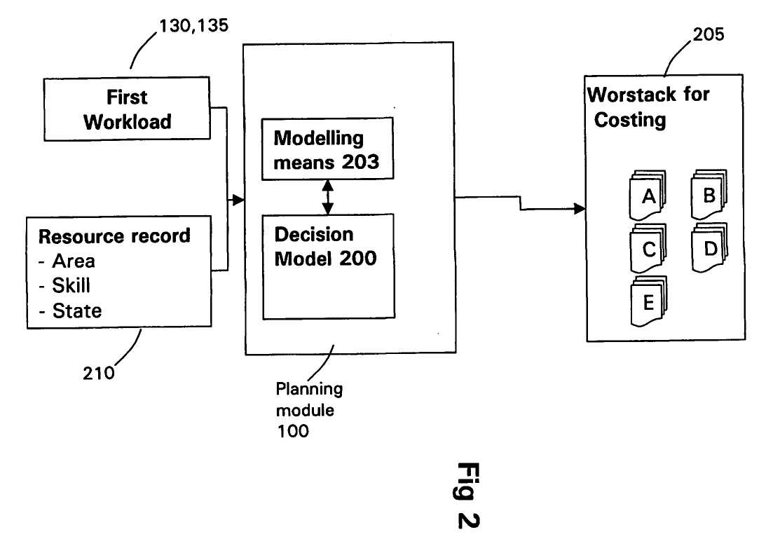

FIG. 2 is a schematic block diagram showing inputs to, and outputs of, an embodiment of the invention;

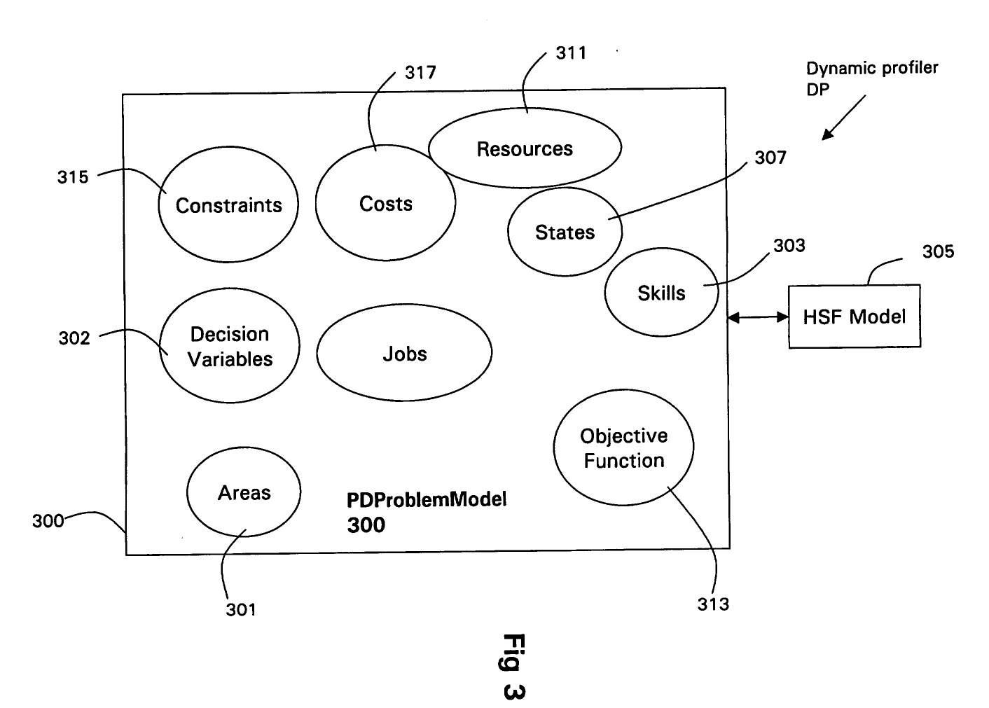

FIG. 3 shows a software architecture for a first embodiment of the invention;

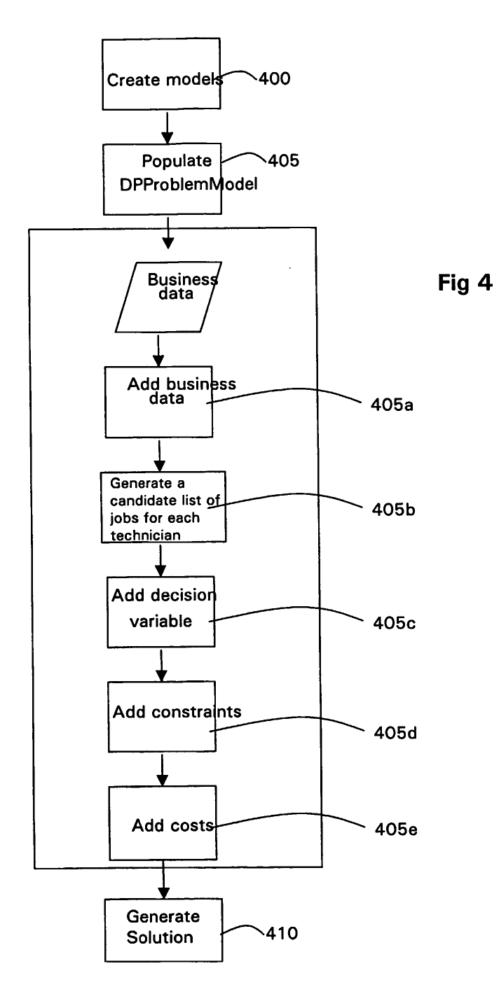

FIG. 4 is a flow diagram showing a method of modifying and selecting resource records according to a first embodiment of the invention;

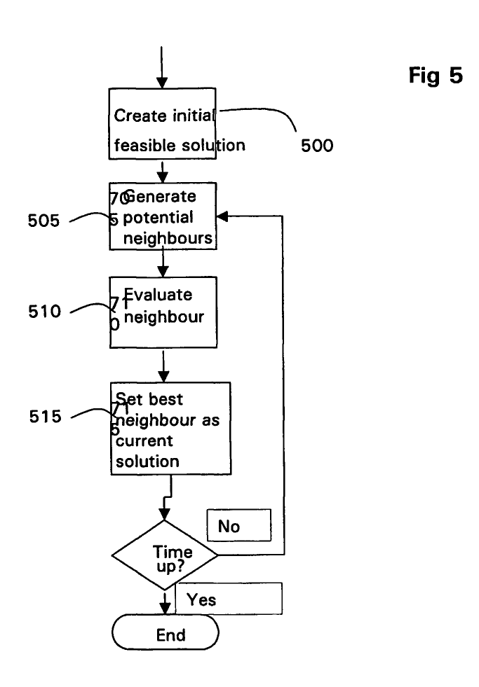

FIG. 5 shows a flow diagram of a recursive method of generating an optimal resource record selection, for use in the last step of FIG. 4;

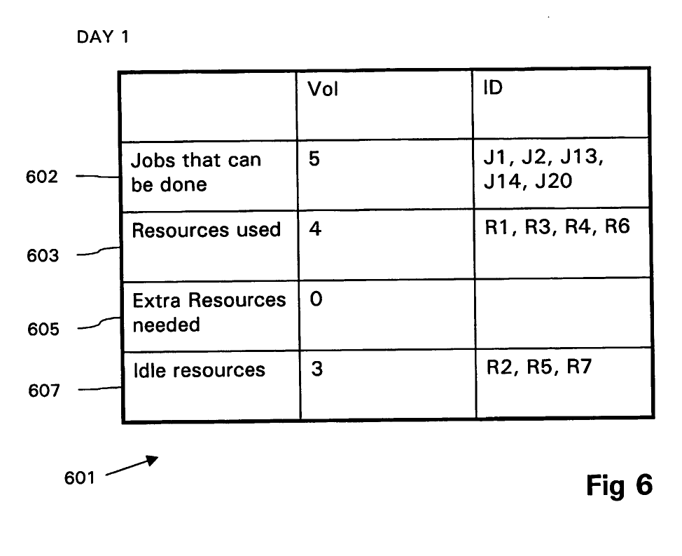

FIG. 6 is a schematic diagram showing an example of a resource plan created in accordance with the first embodiment of the invention;

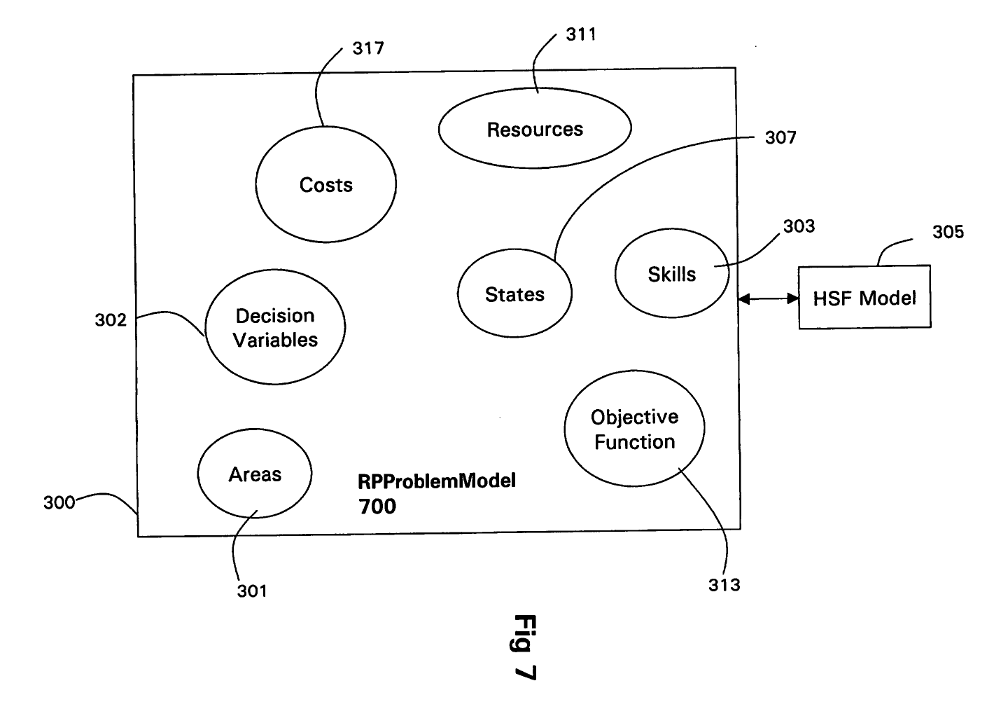

FIG. 7 is a schematic block diagram showing a software architecture for a second embodiment of the invention;

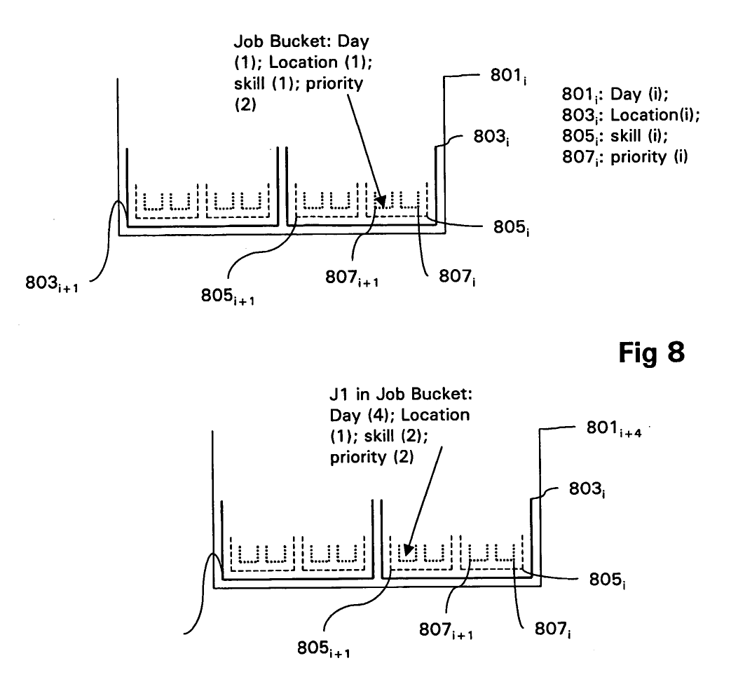

FIG. 8 is a schematic diagram showing a representation of jobs and resources for use in the second embodiment;

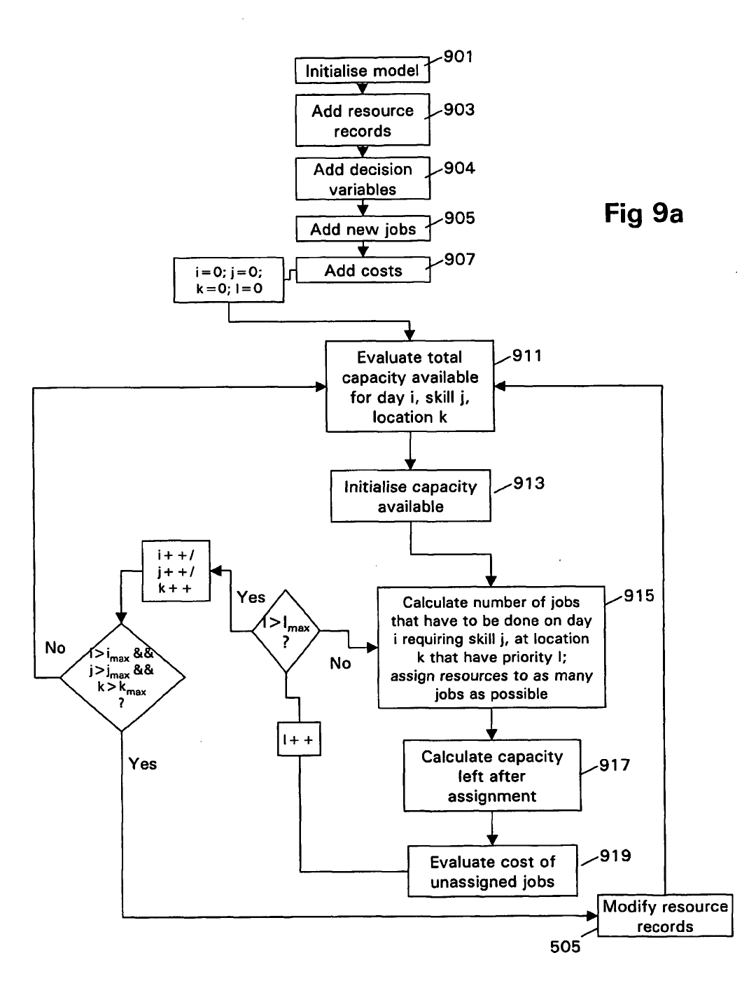

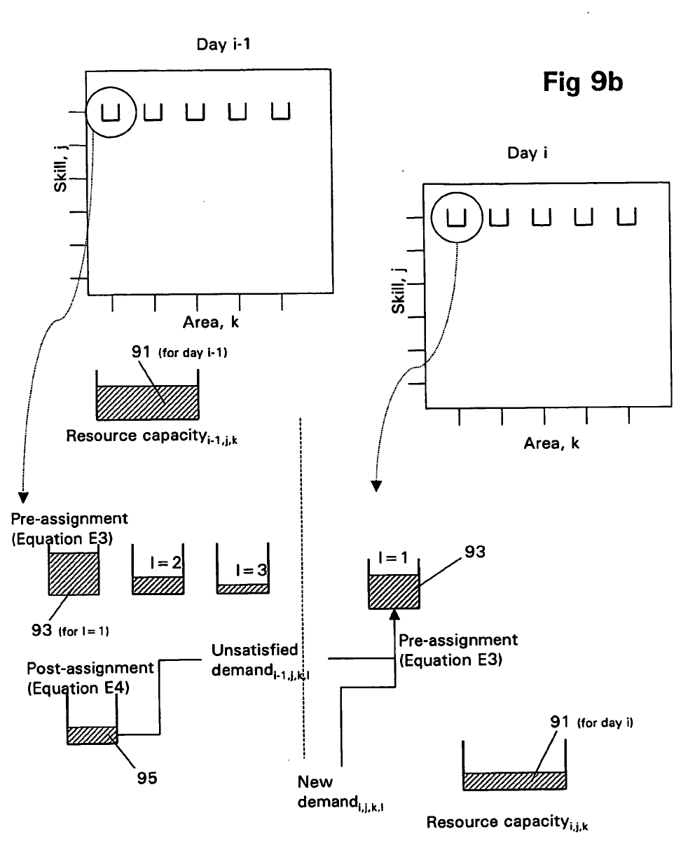

FIG. 9a is a flow diagram showing a method of modifying and selecting resource records according to the second embodiment;

FIG. 9b is a schematic block diagram illustrating parts of the method shown in FIG. 9a; and

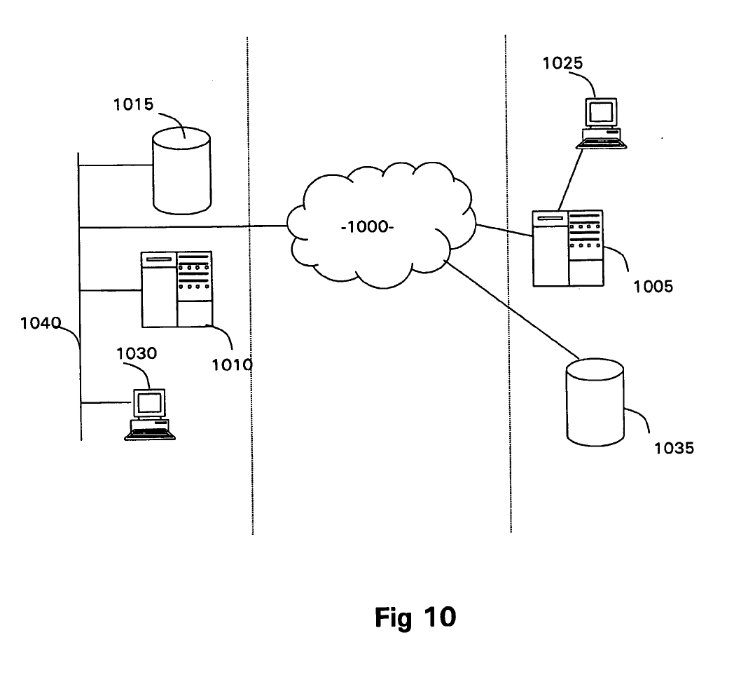

FIG. 10 is a schematic diagram showing an infrastructure arrangement, which may be used to run and configure embodiments of the invention.

### OVERVIEW OF OPERATING ENVIRONMENT FOR EMBODIMENTS OF THE INVENTION

FIG. 1 shows an overview of a resource management system 101 in which an embodiment of the invention may operate. The resource management system 101 uses two kinds of workload data: first data 130, 135 and second data 120. The first data 130, 135 can include a combination of forecasted jobs and jobs that have been carried over from previous weeks (so-called workstack jobs). The first data 130, 135, together with resource records 140 relating to available resources, are input to a resource planning module 100, which draws up resource plans and modifies resource records on the basis thereof. Essentially the resource planning module 100 works on a week's worth of first data 130, 135 by organising the data into daily resource plans, and for each capacity plan, evaluating over- and under-utilisation of resources on the basis of information in the resource records 140. The resource planning module 100 is arranged to modify the resource records and re-evaluate resource usage, with a view to identifying resource records that satisfy some predetermined utilisation criterion.

The output of the resource planning module 100—namely capacity plans and modified resource records—is input to a deployment module 105, which feeds in daily deployment plans 110 to the scheduling part 115.

The second workload data 120 comprises actual jobs that are to be scheduled, and typically fall within a timescales such as a day. The actual workload data 120, together with the deployment plans 110 that are output from the deployment module 105, are used by the scheduling part 115.

Embodiments of the invention are concerned with the resource planning module 100 and the deployment module 105.

### Overview of an Embodiment of the Invention

As stated above, in known systems, resource components have resource records associated therewith. However, the resource records are input to the system as fixed data, which the system has no ability to amend or select from. This is unsurprising since the data is based on fact: for instance resources are either available or they are not available and they will be equipped with one or more of a range of capabilities. However, it has been recognised in making the present invention that it is possible to change one or more attributes of a resource component, for instance in the light of workload. That is, resource components can for instance be taken in and out of service, moved geographically or in a network, or can have capabilities added or removed. In this approach, workload can at least to some extent drive the resource availability rather than the other way around and it is advantageous if the system then can select and assign the resource records.

In embodiments of the invention resource planning is considered to include a process whereby resource records are modified in order to match available resources to workload. For clarity, this process is hereinafter referred to as “resource profiling”. It will be appreciated by a skilled person that resource profiling can be viewed as an integral part of resource planning.

In the following description, a first embodiment of the invention is described in the context of generating resource records in the form of an engineering team of technicians. As described above, a resource record is a set of data describing the attributes of a resource, for example skills, working areas, availability and so on, and can alternatively be referred to as a profile. The first embodiment is concerned with generating deployment plans 110 for input to the scheduling part 115.

An overview of the mechanism of resource profiling according to embodiments of the invention is shown in FIG. 2. A set of resource records 210 is elected, for example by starting with a default set, and, together with first data 130,135, is input to the resource planning module 100. The first data 130, 135 comprises a workstack of jobs of different types “A” to “E”. The resource planning module 100 includes means 203 for making and running a model 200, which model is arranged to model the effect of the resource records 210 on the input workstack 130, 135 and to output a workstack for costing 205. The workstack for costing 205 is the residue of jobs of types “A” to “E” left after the time period. The model 200 selects a new set of resource records 210 and repeats the modelling exercise. The resultant workstacks for costing 205 can then be compared in order to identify a set of resource records 210 involving a minimal residue. Assignment costs associated with the resource records themselves can also be taken into account in optimising resource records.

Apparatus embodying the means 203 for making and running the model is, in a first embodiment of the invention, referred to as a dynamic profiler DP and is described in more detail with reference to FIG. 3. The dynamic profiler DP has two primary components, a problem model 300, referred to herein as the “DPProblemModel” 300, and a heuristic search framework model 305 (the “HSF Model” 305). The models 300, 305 are specific instances of the generic model 200 described with reference to FIG. 3. The models 300, 305 may be built using iOpt™, the Java-based framework for modelling and solving optimisation problems referred to in detail in Appendix C. The dynamic profiler DP first creates a model DPProblemModel 300 of the profiling problem and then inputs the created model 300 to the HSF model. The HSF model essentially acts as a solution generator, and is arranged to manipulate the DPProblemModel 300 to generate different resource records. In conjunction with the DPProblemModel 300, the HSF model 305 is arranged to evaluate the different resource records and select one(s) that satisfy certain predetermined criteria, such as minimising costs and satisfying certain constraints.

The structure of the model 300, created by the dynamic profiler DP, will now be described, with reference to FIG. 3.

The DPProblemModel 300 created by the dynamic profiler DP comprises a plurality of modules, some of which represents a concept: Area 301, Skill 303, State 307, Job 309 and Resource 311, and some of which represent conditions and constraints imposed upon the concepts: objective function 313, constraints 315, cost 317. In at least some embodiments, the DPProblemModel can be defined using object-oriented techniques, so that each concept is represented by a class. Table 1 describes object-level descriptions of DPProblemModel, Area, Skill, State, BasicTask (i.e. job), Resource (i.e. technician).

TABLE 1
Concepts of the DPProblemModel 300

| Concept | Parameters |
|---|---|
| DPProblemModel | Areas, Skills, States, Jobs, Technicians, decision |
| | variables, objective function, constraint model, cost |
| | model |
| Area | Name, x, y, radius |
| Skill | Name |
| State | Name, duration |
| Job | x, y, required skill, unallocation cost |
| Technician | skill domain, skill productivities, skill preferences, |
| | area domain, preferred working radii, area preferences, |
| | state domain, state preferences |

The modules of the problem model 300 are now described in more detail:

Decision variables module 302 include attributes (components of the resource records) which can be assigned or allocated to each technician and comprise:
area
skill
state
   Objective Function module 313 is a function expressing the objectives to be achieved in optimising resource records for technicians. It has two components in the present embodiment, both of which can apply current business constraints to the DP. The first component allows preferences to be applied in assignment of the decision variables to resource records. The second component applies to maximising the quality of service in allocation of jobs. For instance, it allows high priority and/or delayed jobs to be allocated before other jobs. If a job has a high priority, then the cost of leaving it unallocated is raised and the second component of the objective function will operate to allocate that job before other jobs.

Constraint Module 315: The constraint module includes functions that are used to validate resource records. In one arrangement the DPProblemModel 300 includes two constraints: the first is the acceptable range of values for each technician of the decision variables (area, skill and state) and the second enforces the matching of the decision variables in a technician's resource record to the attributes of each job allocated to that technician. The constraints module includes a feasibility measure, which is a measure of whether any aspect of the assignment of decision variables to a technician's resource record violates any of the constraints. An example of the form of the constraint module 315 is defined in Appendix B.

Costs Module 317: The cost module includes functions used to evaluate costs. In one arrangement the DPProblemModel 300 comprise assignment and allocation costs: assignment costs are the costs of assigning values to the decision variables in a technician's resource record, taking priorities into account (described below) in support of the first component of the objective function; and allocation costs are the costs of allocating jobs to technicians, taking priorities into account in support of the second component of the objective function. An example of the form of the cost module 317 is defined in Appendix A.

The dynamic profiler DP acts as a resource manager, providing a central repository of concepts (decision variables and constraint specification), transaction management, constraint checking and costing. The dynamic profiler DP is arranged to:
define decision variables 302 of the problem 300; add technicians 311 to, and remove technicians 311 from, the DPProblemModel 300; add and remove jobs to the DPProblemModel 300; offer lookup services (e.g. technicians, jobs, areas, states, skills etc) for other modules; define an objective function 313 for the problem 300; define constraints 315; request costs 317 associated with a resource record; check the feasibility of values assigned to attributes in a resource record; and request allocation cost.

The data used to populate the modules 301 . . . 317 is stored in a database (not shown) and read by the dynamic profiler DP when populating the model 300. This is described in more detail below (step 405a and subsequent steps).

This data includes area, state, skill information for technicians, and area, skill, state, costs (each area, skill and state has an assignment and unallocation cost) and priority for tasks. The technician information defines:
a technician's Preferred Working Area (“PWA”), which denotes a Preferred Working Location—Preferred Working Radius (PWL-PWR) pair, and effectively limits the jobs that can be allocated to him. A PWA can be a circle defined by the preferred working location (PWL) and preferred working radius (PWR). Alternatively postcodes and building addresses can be used to define a PWA. Given a global area-set of {A1, A2, A3, A4} (defined in areas module 301) a technician's area domain could be {A1, A4};
a technician's skill set, which define the tasks that the technician can carry out. Each technician has a set of possible skills, which is a subset of all potential skills (all potential skills are defined in the skills module 303). For instance, a technician qualified for test, repair and provision tasks will feature the potential skill-set {“test”,“repair”,“provision”}. However, a subset of a technician's potential skills, referred to here as “essential skills”, can be used to provide skill focussing. This facility allows a user and the system to focus individuals on particular skills in order to resolve skill shortages. For example, the technician may have been allocated the essential skill-set {“repair”} if there is a repair skill shortage.
   productivity associated with skills in the potential skill set, expressed as a productivity rate. The productivity rates determine the number of jobs requiring a particular skill that can be executed by the technician, for instance in one day. a technician's state, which classifies his work availability.Technician states are classified as one of the following: 0.0, 0.25, 0.5, 0.75, 1.0 (all potential states are defined in states module 307). A technician with a state of “0.0” is unavailable for work, 0.25 denotes available to work a quarter of a day and so on. These states affect the number of jobs that can be allocated to a technician. The states are not mutually exclusive. A technician could be off but available for overtime, thus his state domain would be represented as {0.0, 1.0}.

The task information includes area corresponding to the task and skills and date required for the task, together with a prioritisation value corresponding thereto. The priority value, which, for example, ranges from 0 to 100, represents some form of prioritisation in the business. For example, if the business dictates that residential jobs have lower priority than business jobs, lower priority values will be assigned to areas and skills related to residential jobs compared to priority values assigned to business jobs. On the other hand if the business dictates that quality of service (in terms of completing jobs) should be improved for a given month, then states of 1.0 will have the highest priority. Priority values are used in costing solutions.

Referring now to FIGS. 4 and 5, operation of the dynamic profiler DP when creating and modifying resource records will be described.

Although shown schematically as step 400, in general, it is assumed that the DPProblemModel 300 has been created. This has been described in the preceeding sections, and essentially involves creating modules 301-317 corresponding to the concepts and conditions, as described above.

Next the DPProblemModel 300 so created is populated with data. This involves reading 405a data identifying jobs to be carried out (forecast and workstack jobs, falling within a timescale such as a week), assignment and allocation costs associated therewith, technician skills, area and state data, and generating 405b candidate list of jobs for each technician, using job data read at step 405a. This data can be read from a database. A job is a candidate for a technician if there is at least one way of building a resource record for the technician so that
(i) The job belongs to the PWA (area) of the technician
(ii) The required skill of the job is included in the selected skill-set of the technician.
(iii) The technician is available to execute the job. The dynamic profiler DP computes the total duration required by the jobs assigned to the technician and then compares it with the availability of the technician. If the total duration is less than or equal to the availability of the technician, then the technician is available to execute the jobs assigned to him. The availability of a technician is represented as a proportion of a working day. The duration of a particular job type is computed by dividing the number of jobs of that type by the productivity of the technician for the required skill of that job type.

Thus the output of step 405b is a set of lists of candidate jobs to be carried out by the technicians (the candidate jobs will fall at different times within the week.

Next, at step 405c, the decision variables (skills, area, state) are added to the decision variables module 302, using technician data read at step 405a, and the constraints corresponding to the decision variables are added 405d to the constraints module 315. As mentioned above, there are two types of constraint, the first being the acceptable range of values for each technician of the decision variables (area, skill and state, and implicitly included in the technicians data read at step 405a) and the second enforcing the matching of the decision variables in a technician's resource record to the attributes of each job allocated to that technician. These allocation constraints can be preprocessed for the candidate jobs generated at step 405b.

Next, at step 405e, costs associated with assignment and unallocation are added to the cost module 317. The costs are described in more detail in the context of modifying and evaluating resource records, steps 505, 510.

Next, at step 610, solution resource records are generated. This involves connecting the DPProblemModel 300 to the HSF model 305, which generates 500 an initial solution comprising a feasible instantiation of all feasible resource records. Table 2 shows a simple example of resource records for three technicians, and Table 3 shows attributes and values thereof for three jobs that have to be carried out.

TABLE 2
Technicians

| | Area (data in | State (data in | Skill (data in | Assigned |
|---|---|---|---|---|
| | area module | state module | skill module | Resource |
| Technician | 301) | 307 | 303) | record |
| R1 | A1, a2, a3 | st1, st2, st3 | sk1, sk2 | {a1, st1, sk2} |
| R2 | A2, a3, a4 | st1, st3 | sk2, sk3, sk4 | {a3, st3, sk3, |
| | | | | sk4} |
| R3 | A1, a2, a3, | st2, st3, st4 | sk1, sk2, | {a4, st4, sk1, |
| | a4 | | sk3, sk4 | sk2, sk3} |

TABLE 3
Jobs

| Job | Area | Required Skill |
|---|---|---|
| T1 | a1 | sk2 |
| T2 | a2 | sk3 |
| T3 | a4 | sk1 |

Each technician has a default resource record, which is a resource record that incurs least cost for the technician and effectively acts as reference for costing skill, area and state; when evaluating resource records (step 515, described below), the HSF model 305 compares the costs associated with a modified resource record and the default resource record. When generating a resource record for day “n”, a default resource record may be the resource record for day “n−1”.

Given an initial feasible solution, the HSF model 305 generates potential solutions 505 and evaluates the potential solutions 510 until a termination condition (that is algorithm dependent) is reached.

There are essentially two approaches to generating (step 505) and evaluating (step 510) resource records: the first treats assignment and allocation variables the same way, assigning values to attributes of the resource record and allocating resources on the basis of the assignment at the same time and then evaluating costs associated with the resource record and unallocated jobs. The second approach separates assignment and allocation and firstly solves the assignment problem by assigning variables to the resource records and evaluating the resource records, and then solves the allocation problem based on preferred resource records. The latter approach is preferred, because in the former approach infeasible solutions can be generated.

Accordingly, during the modification step 505, the HSF model 305 generates a neighbourhood for the current resource records using a heuristic search method selected by the HSF model 305. This method can be specified by a user, or selected automatically by the HSF model 305 (examples of neighbourhoods are described in Appendix C).

A neighbour represents potential resource records and is evaluated 510 with regard to the success, or otherwise, of allocating jobs to the technicians on the basis of the resource records.

Resource record modification (generating moves on the resource record) involves altering, adding or deleting values for its attributes. Attributes of each resource record that can be altered include: area within the region; skill set; availability. Resource record alterations affect costs: a workload involves different types of jobs, and different types of unallocated jobs incur different costs to the business. For instance, certain types of job may have a higher priority because they are subject to premium service level agreements. A backlog in this type of job represents a higher cost to the business if it remains unallocated, so that resource records which enable successful allocation of high priority jobs can have comparatively low costs associated therewith.

The mechanism for evaluation (step 510) involves a call to the constraint and cost modules 315, 317 in the DPProblemModel 300.

In overview, the costing part of step 510 evaluates costs associated with travel, area, skill-sets and states for the workforce and the set of unallocated jobs. Individual costs are aggregated across the whole workforce or work pool. Weights can be introduced to allow prioritisation of, say, travel, over unallocation of a job.

In detail, the costing part of step 510 involves assignment of cost functions in the cost module 317, comparing a current resource record (i.e. current assignment) with the default resource record and noting the differences between them. The priorities associated with the job for skill, state and area are used to calculate the differences. Unallocation cost functions in the cost module 317 review the priority associated with the job and identify a cost associated therewith: the higher the priority, the higher the cost of leaving a job unallocated, taking into account a date by which the job must be done (read in at step 405e). Additionally the costing step can include evaluating travel costs associated with the resource record by means of travel costing functions (in the costing module 317, not described above). These travel costing functions calculate the distance between the centroid of the jobs allocated to a resource and its preferred working location (PWL). A lower travel cost denotes a lower resource utilisation cost.

The constraint checking part of step 510 involves discarding infeasible solutions, and ranking feasible ones according to the criteria defined by the algorithm in use by the HSF model 305 (be it Simulated Annealing, Tabu Search etc.).

The HSF model 305 then selects 515 the best solution on the basis of minimum cost, taking account of the costs associated with the default profile (described above).

A potential use of embodiments of the invention is in raising an alert in the event of over- or under-utilisation of a resource. Concerning over-utilisation, a further cost type, referred to as a utilisation cost, could be applied to the resources themselves. In general, a resource would have zero utilisation cost but a “dummy” resource, or resource type, might be added which is allocated a relatively high utilisation cost, such as 10,000 units. The domains of the dummy resource might for instance be supersets of all known domains. In essence, a dummy resource can do everything, but, as it has a high utilisation cost associated therewith, it is not normally in the interest of the planning module 100 to use it. If such a resource is selected for resource record assignment after optimisation of resource records, this can be used as an indicator that available resources are very likely to be overstretched after scheduling. When the dummy resource is selected, the planning module 100 can be arranged to generate an alert requesting an additional resource or a decrease in workload.

Conversely, the dynamic profiler DP can be used to predict underutilisation. If, after optimised profiling, there is a pool of unallocated jobs and some resources have no jobs allocated to them, this indicates either that there is simply too much available resource or that the available resources are of the wrong type in at least one respect.

Once a best solution has been selected (step 515), the dynamic profiler DP populates a plurality of resource plans, each corresponding to a single day's worth of jobs (identified from the workload data read in at step 405a). Referring to FIG. 6, for a particular day (e.g. day 1), a resource plan 601 comprises jobs 602 that can be carried out that day, resources 603 that have been identified as able to carry out those jobs, an estimate of resources 605 required to clear all of the jobs in that day and an estimate of resources 607 that will be idle that day. Where resources are identified, the resource plan also includes their corresponding records. The dynamic profiler DP inputs these resource plans together with the resource records identified at step 515 to the deployment module 105, which formulates deployment plans 110 on the basis thereof for input to the scheduling part 115.

### Second Embodiment

A second embodiment analyses resource utilisation based on the number of resources and their level of productivity, but it does not attempt to allocate actual jobs to resources. Thus it is more coarse-grained than the first embodiment.

Referring to FIG. 7, the second embodiment of the invention is generally referred to as planner RP, and includes a RPProblemModel 700 and a HSF model 305. The RPProblemModel 700 and HSF model 305 are generally similar to the DPProblemModel 300 and HSF model 305 described in the context of the first embodiment and will not be described further in detail.

In this second embodiment, the RPProblemModel 700 effectively filters jobs into so-called job buckets. As can be seen in FIG. 8, a job bucket identifies a job in terms of:
normalised execution date for a job (normalised with respect to the total number of days for which resource plans are required);
area job located in;
number of skills; and
priority associated with the job.

The total number of job buckets is thus the multiple of the total number of days in a resource plan; the total number of areas in which a job is located; the total number of skills required to carry out all jobs; and the total number of priority ratings. Each job bucket contains zero, one or a plurality of jobs that need to be carried out.

In the representation shown in FIG. 8, buckets are nested within one another: there is one bucket 801 for a day of a resource plan, and that bucket 801 contains buckets 803 representative of all locations (or areas), each of which area buckets 803 in turn contains buckets 805 representative of all skills, each of which skills buckets 805 contains buckets 807 representative of all priorities.

The attribute values of individual jobs determine which of the job buckets a job is assigned to; for example, referring again to FIG. 8, job J1, which is of low priority and requires to be executed on day 4 of the resource plan in area A1 and requires skill sk2, will be assigned to job bucket (4, A1, sk2, low).

The technicians are then similarly filtered into buckets, herein referred to as resource buckets. Each resource bucket represents a resource in terms of: normalised execution date; area resource located in; and number of skills available to resource.

Thus the resource buckets are related to the job buckets in the following manner: for each resource bucket there is a plurality of job buckets, each having a different priority: e.g. for a given day, area and skill, there is an urgent, medium and unimportant job bucket.

A job bucket and a resource bucket can be described as having a “size”, which is essentially the number of jobs and resources respectively that have been assigned to a respective bucket. In the case of the resource buckets, the size thereof is modified by a productivity value and availability. This means that if, for example, technicians T1 and T2 both have skill sk2, but T1 is far more productive than T2, T1's contribution to the resource bucket corresponding to sk2 will be larger than T2's contribution (assuming area and state to be the same).

The RPProblemModel 700 systematically works through each job bucket in accordance with priority, firstly selecting the most urgent job bucket for a first day, first area and first skill. It then reviews the resource bucket corresponding to this selected job bucket (i.e. the resource bucket tagged first day, first area and first skill), and, if there is resource available to complete the job(s), the size of the selected job bucket is reduced by the size of the resource available. The RPProblemModel 700 repeats this for all jobs in the selected job bucket, and, once the size of the selected job bucket has been reduced as much as possible, it moves onto a second job bucket—e.g. the first day, first area and first skill, medium priority bucket. The RPProblemModel 700 repeats the review process described above. This is repeated for all of the job buckets corresponding to the first day. Having reviewed the job buckets in respect of the first day, the RPProblemModel 700 moves onto the second day and repeats the review process in respect of jobs filtered into job buckets corresponding to the second day. This is repeated for all days in the resource plans.

For at least some of the job buckets, it is likely that there will not be sufficient resources to meet the job requirements; for each job bucket, the RPProblemModel 700 evaluates the cost associated with size of job bucket left after the review process.

The HSF model 305 modifies the resource records, by means of a heuristic search method, arranges the new resource availabilities into resource buckets as described above and repeats the attempted job bucket reduction process for the modified resource buckets.

Each time the resource records are modified the HSF model 305 evaluates a cost associated therewith, and records which of the resource records yields a lowest cost.

This second embodiment does not explicitly allocate jobs to individual technicians, but it works out whether or not the collective resource availability can meet the job requirements.

The second embodiment is now described in more detail, with reference to FIGS. 9a and 9b, for the example of allocating work to a work force of technicians.

As for the first embodiment, the RPProblemModel 700 and HSF models 305 are created, shown as step 901 in FIG. 9a. Thereafter the technicians, in particular the attributes of the technicians (state, location, skill(s)), are added 903 to the model 700. The decision variables and jobs to be carried out are then added 904, 905 to the model 700, characterised by execution date, location of job, skill(s) required for the job and priority of the job. The costs associated with the jobs are then added 907 to the model 700.

The RPProblemModel 700 evaluates jobs to be carried out as a function of day, skill, area and priority, and, using the information in the resource records, evaluates the capacity available for each combination of day, skill and area (each resource is assumed to use one skill each day).

Accordingly, referring also to FIG. 9b, for a given day i, the RPProblemModel evaluates 911 total capacity available 91 on a day; for all j,k on day i:

$$Resource {capacity}_{i , j , k} = {\sum }_{r = 0}^{r = riot} [ state on day i \times productivity of resource r in respect of skill j \times capacity of resource r in area k ] ( i , j , k \text{:} i ≡ day ; j ≡ skill ; k ≡ area ) \qquad ( E1 )$$

It then initialises 913 the capacity available to meet the jobs of all priorities having skill j and area k on that day to this total resource capacity:
capacity left_{i,j,k,I=0}=Resource capacity_{i,j,k}
(I=1 high priority; I=0≡initial conditions) (E2)

The number of jobs to be done 93 having priority I (demand_{i,j,k,I)} is then calculated 915: this is made up of new jobs assigned to day i that have priority I (new jobs_{i,j,k,I}), and unassigned jobs from the previous day that have priority I (Unsatisfied demand_{i-1,j,k,I}):
demand_{i,j,k,I}=new jobs_{i,j,k,I}+Unsatisfied demand_{i-1,j,k,I}
//unsatisfied demand 95 (i.e. jobs not carried out in bucket (i-1,j,k,I) are carried over to the equivalent bucket (i,j,k,I) in the next day (E3)
where
Unsatisfied demand_{i,j,k,I}=demand_{i,j,k,I}−capacity left_{i,j,k,I-1}
//unsatisfied demand on bucket I=demand on bucket I−capacity left after satisfying bucket I−1
// i.e. unsatisfied demand [for the highest priority bucket]=
// demand on hi′ priority bucket−total capacity available
// unsatisfied demand [for the medium priority bucket]=
// demand on med′ priority bucket−capacity available after satisfying the hi′ priority bucket (E4)
In other words, the number of unassigned jobs having priority I is given by the difference between the number of jobs to be done having priority I and the capacity available to do those jobs. Clearly as the RPProblemModel 700 moves through the different priorities on day i, the capacity available (capacity left_{i,j,k,I}) decreases because resources are effectively assigned to jobs. Thus the RPProblemModel 700 calculates 917:
capacity left_{i,j,k,I}=capacity left_{i,j,k,I-}1−demand_{i,j,k,I}
//capacity left after satisfying bucket I=capacity left after satisfying bucket I-1−demand on bucket I(E5)
In addition, a cost associated with the unassigned jobs (Unsatisfied demand_{i,j,k,I}) is evaluated 919:

$$Cost unsatisfied demand = {\sum }_{for all i , j , k , l}^{} Unsatisfied {demand}_{i , j , k , l} \times {weight}_{i} \qquad ( E6 )$$

Where weight_{I} is dependent on the priority associated with the job (higher priority jobs incurring higher costs). Calculations (E1- E5) are repeated for all days i (each day in the resource plan), all skills j, all areas k and all priorities I, whereupon the overall cost is calculated (E6).

The HSF model 305 then modifies 505 the resource records, and steps 911-919 are repeated for the modified resource records. In one arrangement of this embodiment, the HSF model 305 modifies the resource records a predetermined number of times, or until an explicit time limit is reached. In another arrangement, the HSF model 305 continues to modify the resource records until the cost evaluated at step 510 satisfies a predetermined cost criterion.

This second embodiment incurs less processing overhead than the first embodiment, because there is no job allocation, meaning that there is no need to explicitly check constraints. In addition the second embodiment can be used to assess resource availability for an arbitrary time period.

Infrastructure Requirements of Resource Management System 101

Referring to FIG. 10, the resource planning module 100 can be supported by platforms such as a server 1010, database 1015, one or more user interfaces 1030 and local and interconnected networks 1040, 1000. FIG. 10 can be viewed in two parts, a first part supporting the resource, planning and deployment modules 100, 105, and a second part 1026, 1005, 1035 supporting scheduling, execution and monitoring modules 115, 125. These modules 115, 125 receive input from the resource, planning and deployment modules 100, 105 and are arranged to schedule actual tasks 120 amongst resources. It will be understood that the arrangement of FIG. 10 is chosen for clarity. In practice, the location of the various modules and data for the planning and scheduling systems is flexible in relation to platform and will be determined by a number of factors such as configuration of legacy equipment, administrative jurisdictions, and logistics.

The inputs to the resource planning module 100, on which it bases its resource deployment plans, are based at least in part on actual workload and performance data which is collected during use of the resources. For example, the actual workload data 120 scheduled by the scheduling module 115 is used to maintain historic data 145, which is input to a forecasting module 150 to obtain forecast workload data 130. Also, any jobs that were input to the scheduling part 115, but were not carried out by the resources are stacked and added to workstack data 135. The workstack data 135 can also comprise jobs arising from ongoing or new service level agreements (“SLAs”).

### APPENDIX A

The class for the cost module 317 for the first embodiment is defined as follows:

```
class CostModel {
double getUnallocationCost(Job j)
{
//Note that in the second embodiment unallocation cost is only
dependent on priority
    // “summing” job lateness and priority
    return (365 − j.lastExecutable)*(j.priority/100);
}
double getTravelCost(Technician t, List j);
{
//Note that this does not apply to the second embodiment
    // returning distance between PWL of t and medium point of jobs in j
    return Distance(t.PWL, getMediumPoint(j));
}
double getAreaCost(Technician t, Pwa n);
{
    return t.Max_Area_Pref + t.Released_Area_Pref −
    t.Assigned_Area_Pref)
}
double getSkillSetCost(Technician t, List n);
{
    return Sum(t.Skill_Prefs) + Sum(t.Released_Skill_Prefs) −
    Sum(t.Assigned_Skill_Prefs)
}
double getStateCost(Technician t, State n);
{
    return t.Max_State_Pref + t.Released_State_Pref −
    t.Assigned_State_Pref)
}
}
```

The global cost function including the weights can then be defined as follows:

```
double g(WorkforcePlan p)
{
return
    unallocationWeight*getUnallocationCost(p) +
    travelWeight*getTravelCost(p) +
    pwaWeight*getAreaCost(p) +
    skillSetWeight*getSkillSetCost(p) +
    stateWeight*getStateCost(p);
}
```

### APPENDIX B

(Re First Embodiment)

The ConstraintModel class (constraint module 315) is defined as follows:

```
class ConstraintModel {
boolean isCompatible(Technician, Job j)
{
    return j.required_Skill isMemberOf t.assigned_Skills
}
boolean isResourceAvailable(Technician t, Job[] j);
    return true if j.duration < = t.availability else false;
}
boolean isWithinRange (Technician t, Job j);
{
    return true if j.x,j.y falls within t.pwa else false
}
}
```

Constraint Optimisation Problem (COP) Formalism

A COP representation (see for example “Foundations of Constraint Satisfaction” by Tsang, published by Academic Press, London, 1993) of a combinatorial optimisation problem is a tuple <X,D,C,F>, where X is the set of the variables to assign, D is the scalar product of the variable domains, C the set of constraints and F the objective function to optimise. A solution of a COP is a tuple of values (X1, . . . Xm), where X contains m variables, such that each xi belongs to the domain Dₓ_{_{I}} of the i-th variable in X. An optimal solution is a solution whereby a maximum number of constraints of C are verified and the objective function value is minimised or maximised. A COP formalism for the present problem definition is as follows:
K={k₁ . . . kₙ}, the set of skill variables.
T={t_{I} . . . tₙ}, the set of state variables.
A={a₁ . . . aₙ}, the set of area variables.
Dₖ⁻={u₁. . . uₙ}, ∀i ∈[1,n], uᵢ is a symbol.
D₁={v₁ . . . vₙ}, ∀i ∈[1,n], v₁ is an integer. Dₜ is the domain for state variables.
Dₖ= [symbol] (Dₖ⁻), domain skill variables.
Dₐ={w₁ . . . wₙ}, ∀i ε[1,n], wᵢ is an integer. Dₐ is the domain for area variables.
X=K∪T∪A
D is defined below.
C={K_{c},T_{c},A_{c}}
K_{c}=skill constraint as defined under Constraint Section above.
T_{c}=state constraint as defined under Constraint Section above.
A_{c}=area constraint as defined under Constraint Section above.
F=p Res+qJob

Each value of a skill variable is a list of symbols, each one representing a technician's skill. Each value of a state variable is an integer representing the id of the technician's state. Each value of an area variable is an integer representing the id of the technician's area.

D is the domain of all the possible solutions of the problem. A first approximation of D can be defined as
D′=(Dₖ x . . . x Dhd t)×(Dₜ x . . . Dₜ)×(Dₐ x . . . xDₐ)
In the real problem definition of Dynamic Profiling, each skill, state and area variable has a specific domain. Thus for each i from 1 to n, for each kᵢ in K, the domain Dₖ_{ᵢ} of the skill variable kᵢ is defined as a subset of Dₖ:Dₖ_{ᵢ} ⊂Dₖ

The same for the state variables:

For each i from 1 to n, for each tᵢ in T,
Dₜ_{ᵢ} ⊂Dₜ

The same for the area variables:
For each i from 1 to n, for each aᵢin A,
Dₐ_{ᵢ} ⊂Dₐ

So the real domain of this problem is a restriction of D′:
D=(Dₖ_{ᵢ} x . . . x Dₖ_{ₙ})×(Dₜ_{ᵢ} x . . . x Dₜ_{ₙ})×(Dₐ_{ᵢ} x . . . x Dₐ_{ₙ})

The objective function F is a function that gives a real or float value from a tuple of values taken from the variable domains. F is defined by the following mathematical formula:

$$F = p * Res + q * Job where Res = {\sum }_{i}^{n} cost ( {a}_{i} ) + {\sum }_{i}^{n} cost ( {t}_{i} ) + {\sum }_{i}^{n} cost ( {k}_{i} ) + {\sum }_{allocatedjobs}^{} travelcost ( {job}_{i} ) . And Job = {\sum }_{unallocatedjobs}^{} unallocatedcost ( {job}_{i} ) .$$

The travel cost is computed as the Euclidean distance between the area assigned to a technician and the centroid (i.e. area) of the jobs allocated to him.
TravelCost jobᵢ)=f(a_{i,}position(jobᵢ)).

### APPENDIX C

Implementation of the Resource Planning Module 100

Embodiments of the present invention can be used in a range of different applications and environments and it is particularly convenient if one or more of the software modules involved in embodiments of the present invention can be put together in a flexible manner which can be tailored at least to some extent to the application or environment it is intended for.

In the first and second embodiments, this is done by separating the module into a representation of the profiling problem and an optimisation algorithm. Importantly, the optimisation algorithm is not fixed but can be selected and modified easily. The problem and optimisation representations can be implemented using the iOpt™ Toolkit, which is a Java-based optimisation toolkit for modelling and solving combinatorial problems. Details of the Toolkit can be found in “Heuristic Search and One-way Constraints for Combinatorial Optimisation” by Voudouris C. and Dorne R (2001), Proceedings of CP′AI-OR2001, Wye College (Imperial College), Ashford, Kent UK and are subject to copending patent application number GB02/00051 in the name of the present applicant. In one arrangement the problem of resource record assignment can be represented using iOPT™ Problem Modelling Framework (PMF) toolkit referenced above. With PMF a problem model (constraints etc. thereon) is expressed using invariants, which are one-way constraints.

It will be understood by one skilled in the art that other constraints, other than one-way constraints, could be used. As an alternative to implementing the dynamic profiler DP and resource planner RP with the iOPT™ toolkit, embodiments of the present invention could interface with constraint programming packages such as ILOG “Solver”, described in Puget, J-F., Applications of constraint programming, in Montanari, U. & Rossi, F. (ed.), Proceedings, Principles and Practice of Constraint Programming (CP'95), Lecture Notes in Computer Science, Springer Verlag, Berlin, Heidelberg & New York, 647-650,1995. The ILOG Solver utilizes multi-way constraints and consists of a number of built-in relations and constraint types, which a user can use to define its problem.

The optimisation algorithm can conveniently be implemented using Heuristic Search Framework (HSF, referred to several times in the description above) provided as part of the iOP™ toolkit. HSF includes a collection of heuristic search algorithms for solving combinatorial and optimisation problems, which can be used to find solutions to the problems that have been defined using the iOpt Problem Model Framework (or that have been defined using other modelling means).

Using the iOPT™ toolkit, the DPProblemModel 300 can be created as described below:

1. Model business data: Analysing the preconditions, resource records, costs and constraints of the DP problem allows five logical concepts needed for reasoning about the problem to be identified, Area, Skill, State, Technician and Job, and the parameters for these are set out in Table 1 above. The entry point to iOpt Toolkit's invariant facilities is the Problem class. The Problem class acts a resource manager for iOpt Toolkit, providing a central repository of the user-defined concepts (classes in Java parlance), transaction management, and constraint checking services. The DPProblemModel class as defined extends the Problem class. A class for each concept can then be created—Area, Skill, State, Job and Resource. At runtime, (step 405) the DPProblemModel instance is populated with instances of Area, Skill, State, Job and Resource.

2. Model decision variables: Since the resource record for each technician must contain Area, State and Skill values, their corresponding domains can be modelled as an IntegerDomainVar (in iOpt Toolkit parlance). These are then added to the DPProblemModel as decision variables (step 405c).

3. Model constraints: As described above, there are three main constraints in DP, and these involve variables Area, State and Skill. To ensure computational efficiency, constraints involving skill and area can be placed in the Job class and the constraint involving state can be placed in the Resource class. Other optional constraints can be added such as “enabled” to the Resource and Job classes. This is to facilitate enabling/disabling of jobs and technicians during a profiling session. A constraint model is implemented which encompasses functions that DP uses to validate resource records. As described in relation to step 405d, the constraints can be preprocessed by building a list of candidate jobs for each technician.

4. Define cost: The objective of DP is to generate optimal resource records. To this end, three types of cost are modelled: assignment costs; resource utilisation costs; and unallocation costs. Assignment and resource utilisation costs are defined for each Technician, whilst unallocation cost is defined for each Job. These costs are added to the DPProblemModel. For a problem instance, an optimal solution of DP represents the minimum cost for that problem instance. The global cost function is defined above under the heading “Cost Model”.

The goal of the HSF component is to generate an optimised solution. To achieve this, the HSF component generates an initial feasible solution. An initial feasible solution is generated in the context that jobs are not allocated to technicians. The Skill, Area and State value domains of the technicians guarantee an initial feasible solution (i.e. Resource record) when all jobs are unallocated, since any assignment of Skill, Area and State values from their corresponding domains is valid. Once a feasible solution has been generated, HSF improves it by using a Local Search (LS) component. Since there are three decision types of decision variables (i.e. Area, State and Skill), three Neighbourhood Search (NS) components are defined (one for Area, one for Skill and one for State). Each NS component generates potential moves for the current solution, evaluates the moves, and selects the best move (i.e. having the minimum value returned by the objective function), thus producing a new solution.

In the second embodiment, the decision variables include Area, Skill, State and resource (no job decision variable), and are characterised by the parameters set out in Table 1. The Problem class of iOPT™ is used to generate the problem model RPProblemModel 700 (step 901), and a class for each concept is created—Area, Skill, State and Resource. The RPProblemModel instance is populated with instances of Area, Skill, State and Resource. Domains corresponding to the decision variables area, skill, state and area are then created and added to the RPProblemModel as decision variables (step 904). In the second embodiment three types of cost are modelled: assignment costs, resource utilisation and “unallocation” (this refers to jobs left undone) costs, each of which apply in respect of a resource. These costs are added to the RPProblemModel (step 907).

Evaluation of Moves:

Broadly speaking a move is evaluated by first unallocating jobs assigned to the corresponding technician, adding the jobs to the pool of unallocated jobs, reallocating the unallocated jobs to the technicians on the basis of the newly modified resource records, and using the objective function to return a value. In this scenario a move producing a minimum value for the objective function is considered to be the best.

In the first embodiment, different neighbourhoods for skill, state and area are defined; when a move is made (i.e. when the value(s) of one of these attributes is/are changed) and a resource record is modified, the performance of that modified resource record is evaluated by attempting to re-allocate jobs on the basis of the modified resource record. The steps involved in allocating/reallocating jobs to resources, in the context of the first embodiment, include:

1. For each technician whose resource record is being changed, identify the technician corresponding to the “move” being made and then unallocate all the jobs assigned to that technician that will make the performance of the “move” infeasible. Thus if a skill is assigned in a proposed move, only unallocate those jobs that make the assignment infeasible. If a state is assigned, only unallocate those jobs that make the assignment infeasible.

2. For each technician whose resource record is being changed, unallocate all the jobs assigned to that technician. Here the type of move is not considered during the unallocation phase.

3. Allocate jobs to technicians who already have jobs allocated to them until it is infeasible to allocate further jobs to those technicians. Only then are jobs allocated to an additional technician. This means that technicians tend to be either fully utilised or not used at all, and maximises resource utilisation.

4. This is a variation of the third form of heuristic, which works to balance rather than minimise resource utilisation. In this case, jobs are allocated to technicians which have been least utilised. In this case, jobs are spread as evenly as possible over the resources.

In the second embodiment, HSF improves a solution by using a Local Search (LS) component, which generates one of the following moves on the solution (step 505):
i) First Neighbourhood: First select a resource at random, then randomly set the values for the resource's state-skill-area decision variables from their respective domains.
ii) Second Neighbourhood: The second neighbourhood is a variant of the first neighbourhood. However, instead of randomly setting values for state, skill and area decision variables, a complete enumeration of values for a state-skill-area combination is generated.
iii) Third Neighbourhood: This is a variant of the second neighbourhood. Here, the approach is near exhaustive in that we eliminate the random generation of resources in the second neighbourhood and repeat the process of assigning values to decision variables for every resource.
iv) Fourth Neighbourhood: Apply first, second or third neighbourhood, and then generate a list of dummy resources that have been used and attempt to replace them with normal resources, in order to minimise the use of dummy resources.
v) Fifth Neighbourhood: Apply first, second or third neighbourhood, and then attempt to swap an expensive resource with a less costly resource; this involves modifying the state of two resources in one move (a dummy resource is more expensive than an overtime resource, which is more expensive than a normal resource).

As for the first embodiment, once a solution has been “improved” by one of the above-mentioned moves, it is evaluated. In the second embodiment this involves identifying a match between resource attributes and job attributes (and a cost associated therewith), on the basis of correspondence between resource and job buckets.

A sixth neighbourhood integrates modification of a resource's attributes with the evaluation thereof. Specifically, the sixth neighbourhood involves the following steps:
(i) for all resources (irrespective of type), set the state attribute to “available”;
(ii) randomly select a “normal” resource, and modify either the skill or area attribute;
(iii) evaluate the cost associated therewith;
(iv) repeat steps (ii) and (iii) for all normal resources until a minimum cost is identified;
(v) repeat steps (ii)-(iv) for “overtime” resources;
(vi) repeat steps (ii)-(iv) for “dummy” resources;

At this point, you do not know which of the resources have actually been assigned to a job, which is undesirable since an essential part of resource planning involves knowing which resources are off-line and can be brought on-line in the event of changes to the workload. Thus in order to identify those resources that have not been assigned to a job, the following steps are performed:
(vii) identify unused dummy resources by changing the state attribute to “off” and evaluating the cost function; if the cost function is unchanged, this indicates that the dummy resource has not been allocated to a job at step (vi). For those dummy resources whose state change does not affect the cost function, keep the state attribute as “off”;
(viii) repeat step (vii) for overtime resources;
(ix) repeat step (vii) for normal resources;
(x) check for exceptions.

Since dummy resources are more expensive than both overtime and normal resources, their state should be set to “off”, and the effect thereof evaluated, before the state attribute of other resource types is changed; thus unused dummy resources are identified first.

As stated above (in the specific description relating to the second embodiment) in one implementation of the second embodiment, each resource bucket has a size, and a resource only contributes to the size of a resource bucket if the attribute values in its resource record match those of the resource bucket. However, each resource can be linked to each resource bucket; this is an implementation issue, and is specific to integrating the invention into the iOPT™ toolkit, which uses invariants. The size of a resource bucket, available capacity (capacity left), jobs to be assigned (demand), unassigned jobs (Unsatisfied demand), and costs are invariants (reproducing equations E1-E6 above):

$$\begin{matrix}Resource {capacity}_{i , j , k} = {\sum }_{r = 0}^{r = riot} [ state on day i ( χ ) \times productivity of resource r in respect of skill j \times capacity of resource r in area k ] & ( E1 ) \\ capacity {left}_{i , j , k , l = 0} = Resource {capacity}_{i , j , k} & ( E2 )\end{matrix}$$

As described in international patent application number GB02/00051, invariants automatically handle updating of conditions and constraints as decision variables involved in the conditions and constraints change. In the second embodiment, as the resource records are modified by the HSF model 305 (step 505), the attributes and values of attributes constituting a resource record change, meaning that resources are effectively moved between resource “buckets”. This is reflected by changes in decision variables (location (k) and skill (j)) and, as these are coupled with the available capacity and demand according to invariant expressions E2, E3, E4, E5, means that the effect of modifying the resource records can immediately be seen.

1. A method of planning resource utilisation in respect of job requirements, the job requirements comprising a plurality of jobs to be carried out over a plurality of days, the method comprising the steps of:
receiving a plurality of resource records, each record being associated with a resource and comprising data identifying attributes thereof;
receiving job data identifying attributes of the plurality of jobs;
evaluating, on the basis of both types of attribute data, a match between resource availability and job requirements;
modifying attributes of at least some of the resource records, and repeating the evaluation step in respect of the modified resource records; and
selecting resource records, for use in scheduling of jobs to resources, that best match resource availability to job requirements.

2. A method according to claim 1, in which the evaluating step comprises
assigning job data to one of a plurality of job groups in accordance with their respective job attributes;
assigning resources to job groups in accordance with their respective resource attributes;
for each job group, identifying a residue of jobs and/or a surplus of resources on the basis of the assigned job data and assigned resources; and
evaluating a cost associated with the identified residue and/or surplus, which cost is representative of said match between resource availability and job requirements.

3. A method according to claim 2, in which the identifying step includes comparing the number of resources with the number of jobs assigned to the job group so as to identify the residue and/or surplus.

4. A method according to claim 1, further including allocating resources to the plurality of jobs on the basis of the modified resource records and evaluating a cost associated with the allocation, the cost being representative of said match between resource availability and job requirements.

5. A method according to claim 4, including receiving a signal indicative of process critical jobs, wherein the evaluation of cost involves weighting a cost associated with unallocation of said process critical jobs so that unallocation of said process critical jobs is increased relative to that of other jobs.

6. A method according to claim 4, including receiving a signal indicative of process critical jobs, wherein evaluation of cost involves weighting a cost associated with assignment of a resource so that the assigned cost of a resource is reduced relative to its unassigned cost.

7. A method according to claim 2 wherein there is a plurality of resource types, and one of the plurality can be assigned to a job group in dependence on availability thereof, and in which the assigning step includes assigning a first resource type to a job group in the event that no other types of resources can be assigned thereto, wherein the resource cost associated with the first type of resource is greater than that associated with any other type of resource.

8. A method according to claim 4, including creating a plurality of resource plans, each of which corresponds to one day of the job requirements and comprises allocated jobs and selected resource records for that day, the resource plans being for use in a scheduling system.

9. A method according to claim 1, in which the job data is representative of unprocessed jobs.

10. A method according to claim 1 wherein the job data is representative of known patterns in workload.

11. A method according to claim 1 wherein the job data is representative of expected demand for resources.

12. A method according to claim 1 further including generating an alert signal in the event that attributes of a modified resource record correspond to those of a predetermined type of resource record.

13. A method according to claim 7, including creating a plurality of resource plans, each of which corresponds to one day of the job requirements and comprises allocated jobs and selected resource records for that day, the resource plans being for use in a scheduling system in which the attributes include a state attribute, wherein the modifying and evaluating steps comprise:
setting state attributes for each resource type to available; for each resource of type other than the first type, performing a process comprising
modifying the value of one of the other attributes corresponding thereto
evaluating a cost associated with the modification and
repeating until the cost satisfies a specified cost criterion;
repeating the process for each resource of the first type, and for each resource of the first type, performing a further process comprising
modifying the state attribute to unavailable;
reviewing the cost function, and
in the event that there is no change to the cost function, setting the state attribute to unavailable; and
repeating the further process for each resource of type other than the first type.

14. Apparatus for planning resource utilisation in respect of job requirements, the job requirements comprising a plurality of jobs to be carried out over a plurality of days, the apparatus comprising:
storage arranged to store
a plurality of resource records, each record being associated with a resource and comprising data identifying attributes thereof, and
data identifying attributes of the plurality of jobs;
receiving means arranged to receive the resource record data and job data;
evaluating means arranged to evaluate, on the basis of both types of attribute data, a match between resource availability and job requirements;
means arranged to modify at least some of the resource records, so as to modify attributes thereof, and
selecting means arranged to select resource records that best match resource availability to job requirements.
